(19) United States
(12) Patent Application Publication
(10) Pub. No.: US 2018/0024944 A1
(43) Pub. Date: Jan. 25, 2018

(54) METHODS AND APPARATUS FOR ACCESS CONTROL IN SHARED VIRTUAL MEMORY CONFIGURATIONS

(71) Applicant: QUALCOMM Incorporated, San Diego, CA (US)

(72) Inventors: Thomas Zeng, San Diego, CA (US); Azzedine Touzni, Carlsbad, CA (US); Mitchel Humpherys, Poway, CA (US)

(21) Appl. No.: 15/217,728

(22) Filed: Jul. 22, 2016

(51) Int. Cl. G06F 12/14; G06F 12/1009

(52) U.S. Cl. CPC G06F 12/1483; G06F 12/1009; G06F 2212/1052; G06F 2212/152

(57) ABSTRACT

Disclosed are methods and apparatus for memory management in shared virtual memory (SVM) systems. The methods and apparatus provide SVM access control on a per master basis through the assignment of a first classification identifier (ID) upon reception of a memory access request from a memory master. The assigned first classification ID assigned to the memory request is compared with a second classification ID stored in at least one page table entry of a page table used to manage the SVM system. The page table entry (PTE) corresponds to one or more memory locations of the SVM being requested in the memory access request. SVM system access operations for the memory access request are then denied if the first classification ID does not match the second classification ID, thereby providing added per master access control for the SVM system.

### BACKGROUND

### Field

The present disclosure relates generally to shared virtual memory management and more specifically to methods and apparatus for Per-master Access Control in a Shared Virtual Memory configuration.

### Background

Shared Virtual Memory (SVM) configurations bring value through ease of programming and area reduction for circuitry in a chip or integrated circuit. In SVM configurations, multiple processors, operating systems, or applications share a virtual memory controlled through the use of a Memory Management Unit (MMU). The MMU manages access from the virtual memory to physical memory locations using address translation of Virtual Addresses (VAs) to Physical Addresses (PAs).

A page table is a data structure used by a virtual memory system in a computer operating system to store the mapping between the virtual addresses and the physical addresses, where a page is a single entry in the page table and is typically the smallest unit of data for memory management in a virtual memory operating system. Virtual addresses are used by the accessing process, while PA's are used by the hardware (e.g., RAM). When a process requests access to data in its memory, typically the operating system will map the virtual address provided by the process to the physical address of the actual memory where that data is stored. The page table is used by the operating system to store mappings of the VA's to PA's, with each mapping also known as the page table entry (PTE).

In some SVM configurations different bus masters, which may be hardware blocks or units, share the same page table used by an Input/output Memory Management Unit (IOMMU) (or System Memory Management Unit (SMMU) in the example of ARM® architecture systems) for non-CPU devices. An SMMU is a hardware and/or software device configured to provide address translation services and protection functionalities to any Direct Memory Access (DMA) capable agent in the system other than the main CPU. This includes hardware accelerators such as graphics processing units (GPUs) and Video Engines (VEs), and simple DMA controllers, as well as complete sub-systems. An SMMU can be implemented as a standalone device or integrated with an existing DMA capable processing unit. The SMMU is designed for use in a virtualized system where multiple Guest Operating Systems (OSs) are managed by a VMM. In particular systems that are virtualized, such as SVM configurations, memory management may further include the use of a two stage address including an Intermediate Physical Address (IPA) that provides intermediate translation from the VAs to the PAs (i.e., VA to IPA and IPA to PA). The first stage, or Stage 1, implements the VA to IPA translation and is designed for use by the Guest Operating System. The second stage, or Stage 2, translates the IPA to the PA. This mapping or translation may be managed with the help of the page table.

Since memory bus masters manage the virtual to physical memory access/mapping with the page table, sharing of the same page table can result in the bus masters scribbling (i.e., writing) over each other's buffers that are not meant to be shared. This scribbling makes it hard to debug memory corruptions. Additionally, such configurations also give up per bus master sandboxing, which reduces security by eroding the ability to securely sandbox or separate memory data.

### SUMMARY

According to an aspect, the present application discloses a method for memory management in a shared virtual memory (SVM) system that includes receiving a memory access request from a memory master, and assigning a first classification identifier (ID) to the memory access request from the memory master. The method further includes comparing the first classification ID assigned to the memory request with a second classification ID stored in at least one page table entry of a page table used to manage the SVM system, the at least one page table entry (PTE) corresponding to one or more memory locations of the SVM being requested in the memory access request. After the comparison, SVM system access operations will be denied for the memory access request if the first classification ID does not match the second classification ID.

In another disclosed aspect, an apparatus for memory management in a shared virtual memory (SVM) system includes means for assigning a first classification identifier (ID) to a memory access request from a memory master. The system further includes means for comparing the first classification ID assigned to the memory request with a second classification ID stored in at least one page table entry of a page table used to manage the SVM system, the at least one page table entry (PTE) corresponding to one or more memory locations of the SVM being requested in the memory access request. The system also includes means for denying normal SVM system access operations for the memory access request if the first classification ID does not match the second classification ID.

According to another aspect, a processor-readable storage medium is disclosed that has one or more instructions that, when executed by at least one processing circuit, cause the at least one processing circuit to assign a first classification identifier (ID) to a memory access request from a memory master in a shared virtual memory (SVM) system. The instructions also cause the processing circuit to compare the first classification ID assigned to the memory request with a second classification ID stored in at least one page table entry of a page table used to manage the SVM system, the at least one page table entry (PTE) corresponding to one or more memory locations of the SVM being requested in the memory access request. Additionally, the instructions cause the processing circuit to deny SVM system access operations for the memory access request if the first classification ID does not match the second classification ID.

According to still another aspect, an apparatus for memory management in a shared virtual memory (SVM) system is disclosed. The apparatus includes at least one storage medium and at least one processing circuit coupled to the storage medium, where the at least one processing circuit is configured to assign a first classification identifier (ID) to a memory access request from a memory master. The at least one processing circuit is also configured to compare the first classification ID assigned to the memory request with a second classification ID stored in at least one page table entry of a page table used to manage the SVM system, the at least one page table entry (PTE) corresponding to one or more memory locations of the SVM being requested in the memory access request. Further, the at least one processing circuit is configured to deny normal SVM system access operations for the memory access request if the first classification ID does not match the second classification ID.

### BRIEF DESCRIPTION OF THE DRAWINGS

FIG. 1 illustrates an exemplary architecture of an SVM system in which the presently disclosed methods and apparatus may be employed.

FIG. 2 illustrates a further exemplary architecture of an SVM system in which the presently disclosed methods and apparatus may be employed where the system utilizes System Memory Management Units (SMMUs).

FIG. 3 illustrates an exemplary diagram of a two stage SVM memory mapping using a System Memory Management Unit (SMMU).

FIG. 4 illustrates an exemplary flow diagram and architecture of a multimedia system to which the present methods and apparatus may be applied.

FIG. 5 illustrates an exemplary architecture for implementing the present methodology providing a modification of Stage 1 permissions in an SMMU or input/output memory management unit (IOMMU).

FIG. 6 illustrates an exemplary architecture or topology for memory access from non-GPU masters that effectuates an added per master memory access permission.

FIG. 7 illustrates an exemplary method for per master memory access permission in a SVM system.

FIG. 8 is a diagram illustrating a simplified example of a hardware implementation for an apparatus employing at least one processing circuitry for implementing the memory management processes disclosed herein.

### DETAILED DESCRIPTION

The following description discloses exemplary methods and apparatus for virtual memory management in a shared virtual memory (SVM) system that afford better debugging of memory corruptions and maintain per bus master sandboxing to increase security in such SVM systems. In particular, the present disclosure provides management of SVM systems that affords control on a per master basis. This may be accomplished by adding an identification (ID) classification or categorization mechanism that can be assigned or attached to particular bus masters using an associated look-up. The identification classification mechanism is attached to a page table radix tree (a data structure), and overlays extant SMMU permission checks based on the added identification classifications to add an additional layer of access control and security. In some aspects, the present methods and apparatus may use available page table bits already present in known page table formats, and Access control Regions (ARs) or Identification (ID) classifications can be defined so only an owner (e.g., an owner bus master) of a private buffer can write to that buffer, preserving sandboxing and preventing scribbling by other bus masters.

It is noted at the outset of the present description that the word “exemplary” as used herein is to mean “serving as an example, instance, or illustration.” Any embodiment described herein as “exemplary” is not necessarily to be construed as preferred or advantageous over other embodiments.

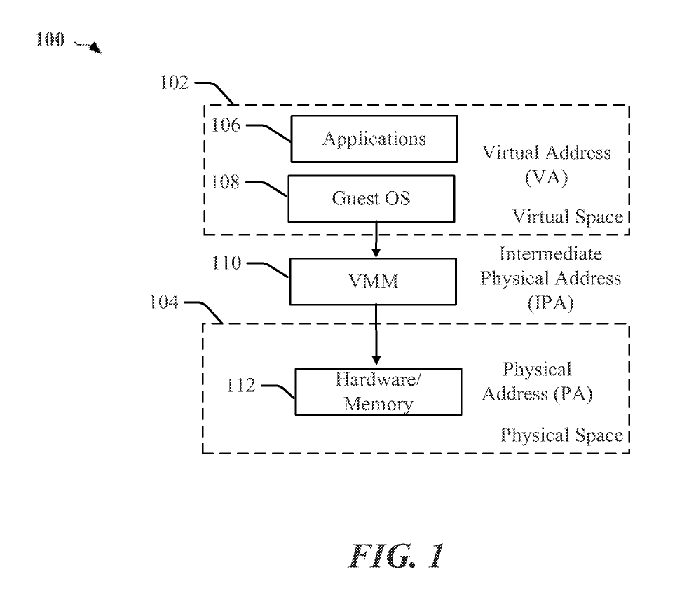

FIG. 1 illustrates an exemplary architecture of a virtualized system 100. The virtualized system 100 may include a virtual memory space 102 and physical memory space 104. Operating in the virtual memory space may be applications 106 and Guest Operating Systems (OS) 108. The software applications and OS operating in the virtual memory space 102 will reference virtual memory locations with Virtual Addresses (VAs), which allows for a greater range of memory addresses, even though the physical memory being accessed does not necessarily physical contain such a range. The VA is translated to an Intermediate Physical Address (IPA) with a Virtual Machine Monitor (VMM) or Hypervisor 110 or similar device or software, which translates the IPA to a Physical Address (PA), in turn in order to properly access memory locations in a hardware memory 112.

In a system where each Guest OS is running inside the VMM, the memory that is being allocated by the Guest OS is not the true physical memory of the system, but instead it is the intermediate physical address. The VMM directly controls the allocation of the actual physical memory in the role of an arbiter of the shared physical resources.

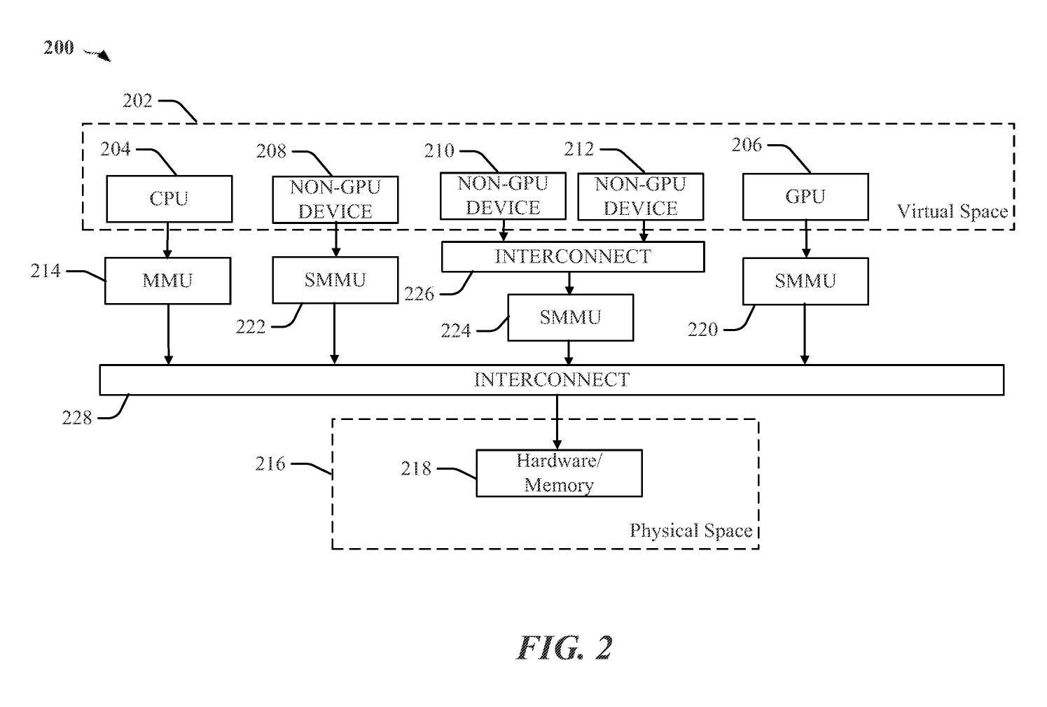

FIG. 2 illustrates an exemplary virtualized architecture 200 illustrating where IOMMU or SMMU devices may be used. The virtual space 202 wherein VAs are used may include various virtual memory accessing devices, such as a CPU 204, a GPU 206, and other Non-GPU devices 208, 210, or 212, which could constitute devices such as Video engines, simple DMA controllers, or complete sub-systems. The CPU 204 interfaces with a Memory Management Unit (MMU) 214, which translates VAs to PAs using in physical space 216, and hardware/memory 218, in particular.

For non-CPU devices such as the GPU 206 and non-GPU devices 208, 210, and 212, these devices access the memory 218 using an IOMMU, an SMMU as shown in FIG. 2, or some equivalent memory management unit. FIG. 2 illustrates various configurations and locations that could be envisioned for SMMUs to provide address translation services and protection functionalities. For example, a GPU 206 may access memory through a single SMMU 220, or similarly a non-GPU device (208, 210, and 212) may access memory through a single SMMU 222. In other examples, a number of devices may be served by a single SMMU, such as the example with devices 210 and 212 and SMMU 224. The devices 210 and 212 in this example may be further connected through an interconnect 226. Furthermore, in an aspect the various MMUs and SMMUs 214, 220, 222, 224 may connected to an interconnect 228, which may be a coherent interconnect in some further aspects to ensure cache coherency between masters.

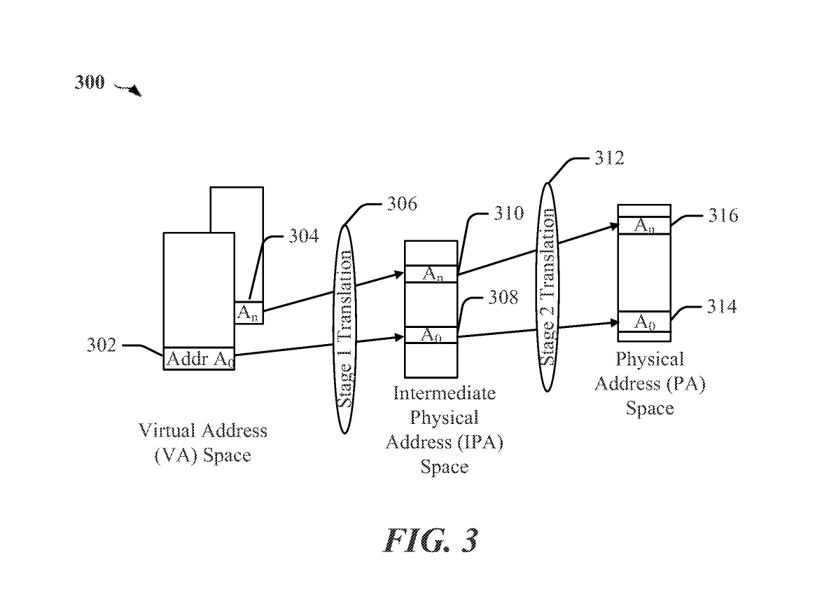

As mentioned before, in certain SVM systems using an IOMMU or an SMMU, these units may be configured to use a two-stage memory access; i.e., (1) VA to IPA in Stage 1 and (2) IPA to PA in Stage 2. FIG. 3 illustrates and exemplary architecture 300 of such a two-stage systems for address translation in which the present methods and apparatus may be utilized, although application of the present invention is not limited to such. As illustrated, virtual address A₀ (302) through An (304) may be accessed by one or more OSs or clients in the virtual address (VA) space. The SMMU or IOMMU (not shown specifically embodied in FIG. 3 but nonetheless the mechanism or means implementing both stage 1 and stage 2 translation in the IPA space) provides a stage 1 translation 306 that translate the addresses A₀ through Aₙ to respective address locations 308, 310 in the IPA space. From the IPA space to the PA space, the SMMU or IOMMU provides stage 2 translation 312 to the actual respective physical memory locations 314, 316 for the IPA addresses 308, 310. The Stage 1 translation may be accomplished with a SMMU or IOMMU that may be implemented in software, hardware, firmware, or combinations thereof, as well as with the utilization of a page table within the SMMU or IOMMU.

Further, the SMMU or IOMMU also serves to translate the IPA addresses to the PA space through the Stage 2 address translation (i.e., IPA to PA address translation and may be implemented in software, hardware, firmware, or combinations thereof. The Stage 2 translation may also be accomplished with the use of a page table within the SMMU or IOMMU.

As mentioned before, the present methods and apparatus utilize a further identification (ID) classification (a classification ID or Access Area ID (“ARID”)) that is used for comparison when a client requests memory access. That is, when a page or other location in the memory is being accessed by a client, the ID classification of the client request is compared to a classification ID that may be encoded in bits within the Page Table Entry (PTE) for that page in the page table. If the ID's match or are compatible, then the request for memory access continues on to SVM memory access, such as access according to the other normal, standard, or customary processes for memory access (e.g., further permission checks). On the other hand, if the classification IDs does not match, the client request will fail and terminate. In an aspect, the present methods and apparatus represent a modification of Stage 1 memory access by the SMMU, and in particular the Stage 1 permission model in order to provide a higher degree of security for memory access. In another aspect, the presently disclosed methods and apparatus add the identification classification on a per bus master basis using extant page table entry (PTE) bits, and determine whether there is a match in the page table entries during a bus master memory request to determine if permission should be granted to the memory location attempted to be accessed.

In one particular aspect, although not limited to such, the identification classification or categorization may be thought of like a color code, where a predefined “Color ID” is assigned to each of the bus masters. Then, when a client (i.e., a bus master) is seeking to access/allocate/deallocate a memory location (e.g., a page), such as through the SMMU, the Color ID is compared to the page Color that is encoded in the PTE bits (e.g., 4 bits in one embodiment). If the Color ID matches the encoded page color, then the SMMU follows standard or normally performed processes (e.g., permission checks, etc.). If no match is found, then the client request fails and is terminated. In this manner, only bus masters with the correct credentials will be able to allocate/deallocate the memory location, preventing scribbling and preserving sandboxing. In an aspect the “Color ID” is a signature or, more generally, a bit mask that serves to classify or categorize the access accorded to a bus master.

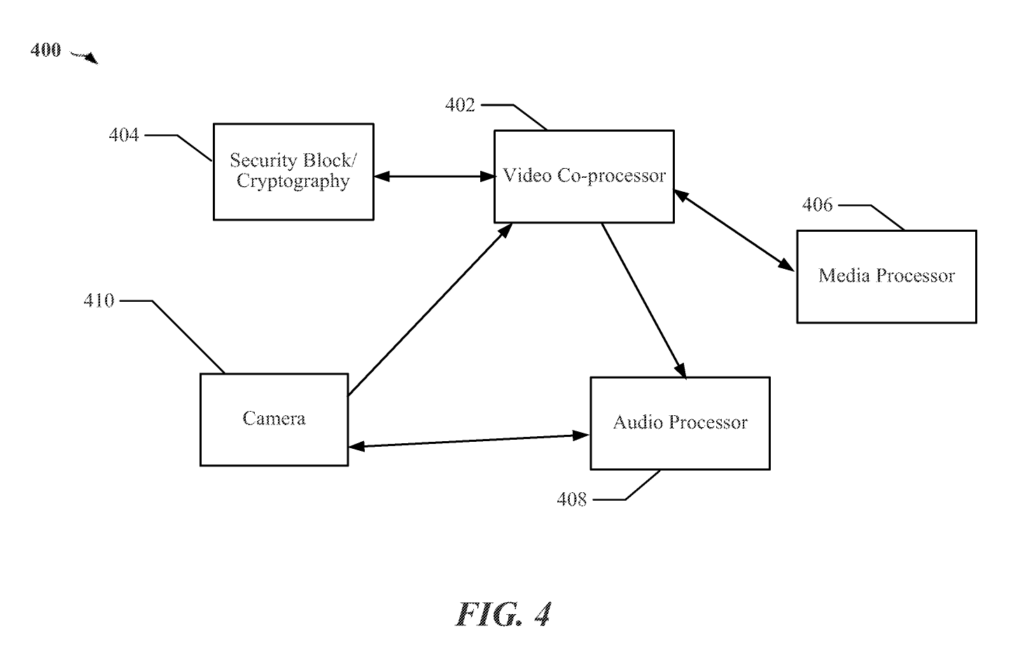

FIG. 4 illustrates an exemplary flow diagram and architecture of a particular system to which the present methods and apparatus may be applied. In the example of FIG. 4, the architecture or system 400 is for a multimedia (MM) system, such as a multimedia system implemented in a mobile device. In this example, various clients or hardware units share a virtual memory and common buffers (not shown in this figure) for memory access requests. The MM system 400 includes a video co-processor 402 that interfaces and shares interface busses with various other devices, such a security block/cryptography block 404, a Media Processor (MDP) 406, an Audio digital signal processor (ADSP) 408, and a camera device 410 to access shared virtual memory. In one aspect, the system 400 may be in a mobile phone, but the applications of the present disclosure are not limited to such.

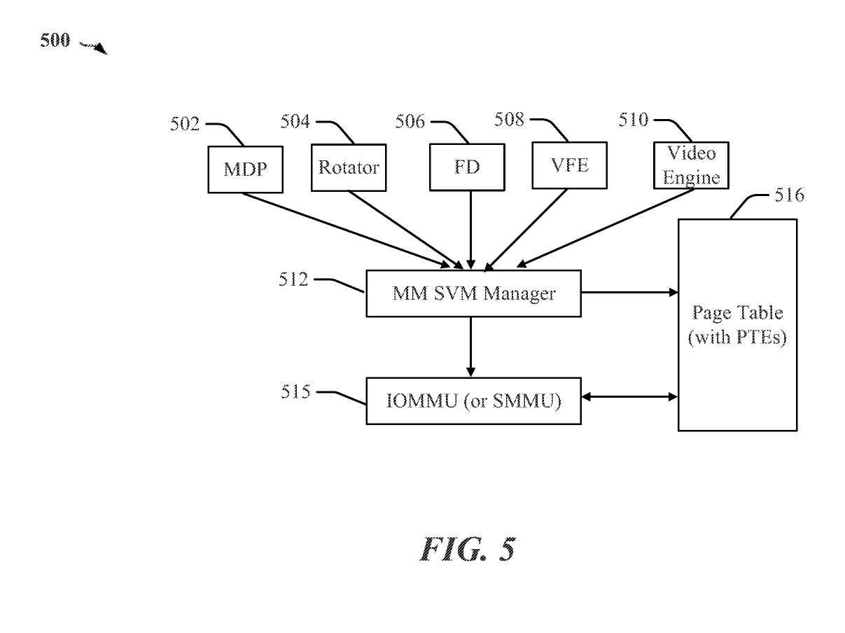

FIG. 5 illustrates an exemplary architecture 500 for implementing the present methodology providing a modification of Stage 1 permissions, although one skilled in the art may envision other architectures that may achieve a modification of Stage 1 permissions with the use of a classification ID. It is noted that this example is given in the context of a multimedia (MM) system, such as an MM system in a mobile device that shares virtual memory among different hardware/software devices In the example of FIG. 5, various device or clients such as a media processor (MDP) 5502, video rotator 504, face detection (FD) unit 506, video front end (VFE) unit 508, and video processor 510 are illustrated for purposes of illustration, but the architecture 500 is merely exemplary and may be applied to numerous other types of systems and clients that share virtual memory. The devices or clients 502, 504, 506, 508, 510 are configured to call an additional driver 512 when making memory master access requests. The driver 512 is termed herein as a multimedia shared virtual memory manager (MM_SVM_mgr) for convenience, but this driver is not limited to such nomenclature and could be simply termed an SVM manager as well. The MM_SVM_mgr is configured to allocate and deallocate memory, as well as map to an IOMMU or SMMU 514.

In operation, the MM_SVM_mgr 512 is configured to assign a classification ID or Color ID to each client (e.g., to each of clients 502, 504, 506, 508, and 510). The MM_SVM_mgr may also assign a VA buffer handle or identification used in a shared VA buffer situation. The MM_SVM_mgr 512 may then allocate the VAs and invoke IOMMU or SMMU Application Protocol Interfaces (APIs) to back the VA buffer. The MM_SVM_mgr 512 may be implemented with software, hardware, or combinations thereof.

In another aspect the MM_SVM_mgr may be configured to write the classification IDs or Color IDs to page table entries in the page table 516 used by the IOMMU or SMMU 514. In a further aspect, the classification IDs or Color IDs may utilize existing PTE bits already available in the page table. In an example, four (4) Access Area PTE bits are available in each PTE of the page table in some existing implementations and these bits may be used to encode the classification IDs or Color IDs for each entry to avoid changing the page table or incurring additional hardware or software cost of additional bits in the table.

It is noted that the MM_SVM_mgr 512, in some aspects, modifies the Stage 1 permission model of extant IOMMUs or SMMUs. Thus, when a client requests access to a VM address, the IOMMU or SMMU will find the page entry (i.e., a leaf page in a radix tree structured page table, which is page entry with no children or further branches) in the page table and check if the classification ID of the client request matches the PTE bits in the page table entry encoded with the classification ID. If there is a match, then the system allows for standard or normally executed memory access processes (e.g., additional permission checks, etc.) to continue in the IOMMU or SMMU, with normal, standard or customary meaning those memory access operations, such as permission operations, that are typically performed in IOMMUs or SMMUs. If not, then the client request fails at the outset, thereby providing an additional layer of security not realized before. Additionally, the SVM manager may be incorporated within the IOMMU or SMMU.

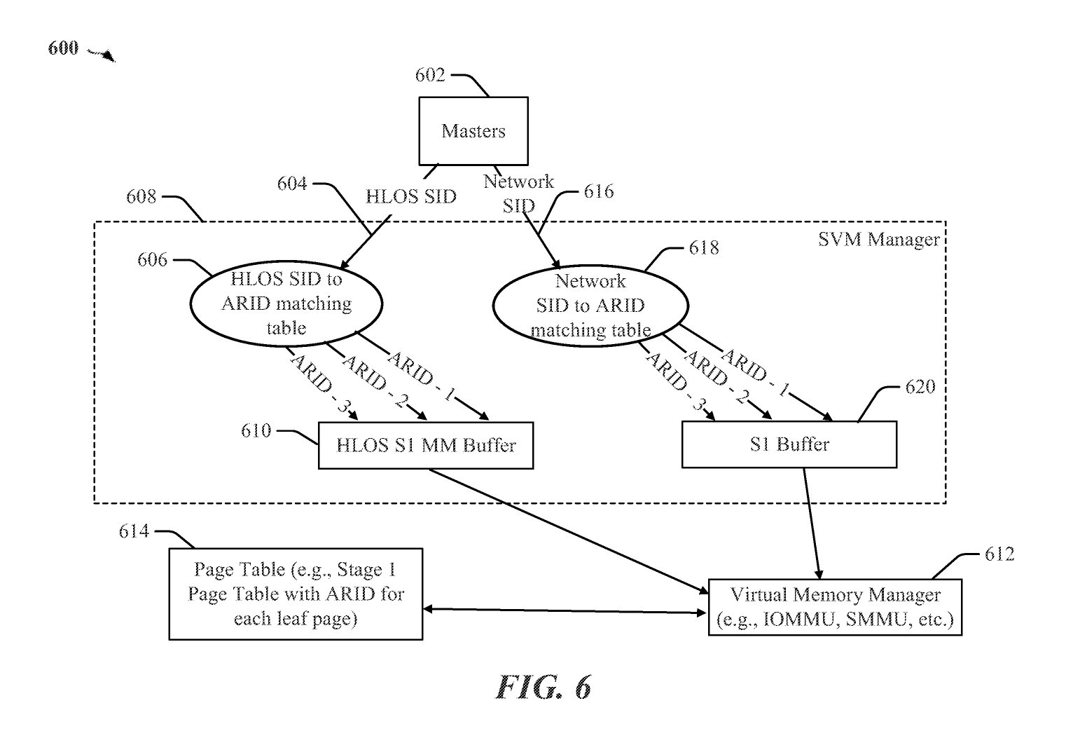

FIG. 6 illustrates an exemplary architecture or topology 600 of the memory access from various devices, and in one particular aspect, non-GPU masters, although the present methods and apparatus are not limited to such masters. In an aspect, the architecture illustrated is for a multimedia (MM) system, such as the system illustrated in FIG. 4. It is noted, however, that the illustrated system is merely exemplary, and the present methodology is applicable to any of a number of various systems utilizing shared virtual memory. The topology 600 illustrates that for non-GPU memory masters 602, as an example, when clients or High Level Operating System (HLOS) request memory access, the multimedia stream identification (i.e., MM_SID) may be matched with or assigned to a classification ID or Access area ID in order to effect an additional layer or overlay of permission protection in the SVM system.

As shown in FIG. 6, one or more memory masters 602 issue memory access requests 604 to a matching table 606 that is used to match the SIDs (e.g., HLOS SIDs such as multimedia (MM) SIDs for a multimedia system) in the requests to classification IDs or ARIDs in the page table 614, which includes the classification IDs or ARIDs for each PTE in the table. It is noted here that, in an aspect, the memory masters 602 are drivers or engines making memory access requests of associated clients to access the shared virtual memory. In some aspects, the masters may be connected via an interconnect bus, but the application of the present methods and apparatus is not limited to such, and each master could be a direct memory access (DMA) as well.

The matching table 606 is utilized to determine or lookup what the classification ID or ARID is for particular SID of the requests from the masters 602 and assign or tag the looked up ARID value to the request before buffering in a common or shared Stage 1 buffer, such as an HLOS multimedia buffer 610 as illustrated. The requests may be assigned ARID values 1, 2, and 3, for example. In a further example, the ARID values may be associated with particular memory locations for particular functions. For example, the ARID-1 could be a classification for memory locations for a multimedia coprocessor (e.g., 402 in FIG. 4), ARID-2 could be a classification for memory locations for a media processor (e.g., MDP 406 in FIG. 4), ARID-3 could be memory locations for a camera (e.g., 410 in FIG. 4), and so on. In other aspects, it is also noted that an ARID or classification ID may be a classification for multiple clients (i.e., two or more). For example, an ARID-4 value could denote memory locations shared by both a media processor and an audio digital processor (e.g., Media Processor 406 and Audio Processor 408 as seen in FIG. 4).

In turn, when the Virtual Memory manager 612 (e.g., an IOMMU or SMMU) receives the memory requests from buffer 610, the ARID assigned to the request by the matching table 606 may then compared to the specific memory location's predetermined ARID stored in the extra bits of each PTE of a page table 614 (e.g., a Stage 1 page table). The PTE associated with the requested memory address in the memory request is looked up in the page table 614 (i.e., the leaf page is located). Since each PTE contains the ARID stored in the extra bits of the PTE, this ARID can be compared with the ARID of the request assigned by the matching table 606 by either the SVM manager 608 or, alternatively, by the manager 612. If the request ARID matches the ARID pre-stored in the PTE, then the request may continue to other standard or normally performed permission checks by the manager 612, for example. Otherwise, the client request fails this initial additional or overlaid permission check at the outset. In this manner, the present methods and apparatus provide the ability to check permission on a per master basis not previously available, thereby affording an extra layer of sandboxing for memory locations that improves the prevention of scribbling or overwriting.

In another aspect, it is noted that other masters of the group of memory masters 602 may relate to memory requests for networking clients, such a device for wireless local area network (WLAN), as well as different types of such WLAN devices (e.g., 802.11ac, 802.11ad, 802.16, etc.), LAN devices, and so forth. This example is illustrated by network requests 616 from one or more of the masters 602 to a matching table 618 for matching the Network SID associated with the request 616 to ARIDs. Similar to matching table 606, the matching table 618 associates or assigns ARIDs to the memory requests prior to buffering in common or shared Stage 1 buffer 620, such as ARIDs 1, 2, and 3, and so on. From here, the Virtual memory manager 612 may check the permission for access through the ARIDs stored in each leaf page requested in the page table 614, thereby effectuating a per master memory access for the network clients and associated masters. It is noted that, in an aspect, the disclosed architecture of FIG. 6, as well as the disclosed methods, effect enabling a more secure control of the data to be managed and consumed by the various masters (e.g., hardware blocks), whether non-GPU or GPU. It is noted that application of the present methods and apparatus to GPU devices is possible, provided that the hardware is designed properly. Examples where a GPU might be used with the present methods and apparatus are in isolated or semi-isolated configurations where a GPU is virtualized or two GPU are instantiated in an ASIC. In such examples, one GPU may be controlled by another chipset through an interface (e.g., PCIe interface) or through a virtual machine on the CPU within a System on a Chip (SOC).

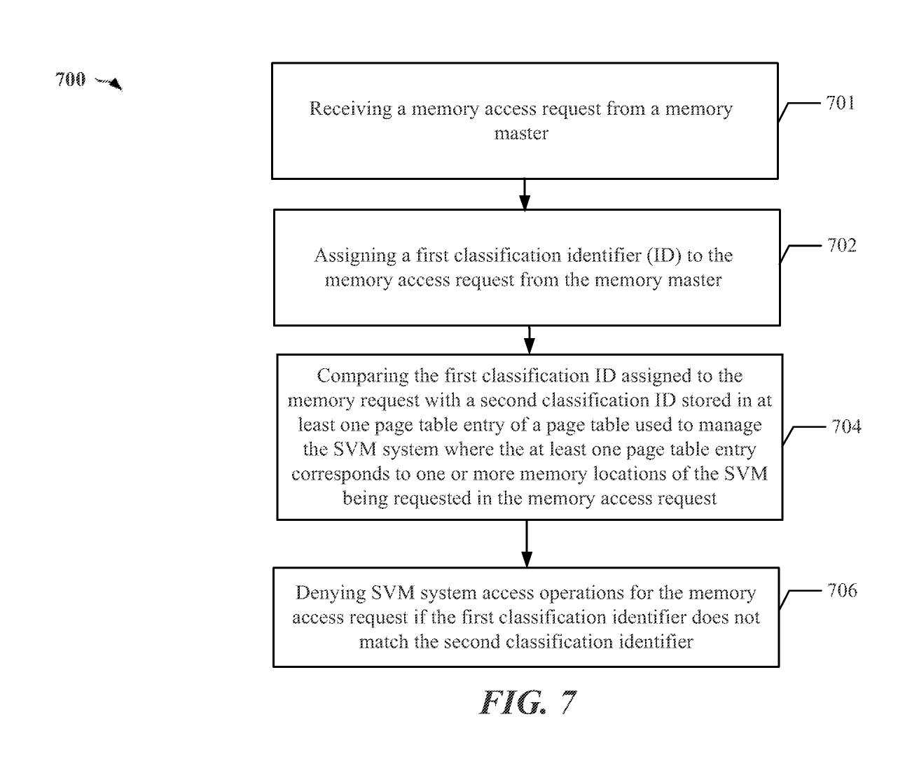

FIG. 7 illustrates an exemplary method for memory management 700 in a shared virtual memory (SVM) system. The method 700 effectuates the per master access for memory requests as described above. As shown, method 700 includes receiving a memory access request from a memory master as illustrated in block 701. After receipt of the request, method 700 includes assigning a first classification identifier (ID) to the memory access request from the memory master as shown in block 702. In an aspect, this assignment or allocation is made by the SID to ARID matching tables 606 or 618 in FIG. 6, wherein the first classification ID (i.e., a first ARID) is assigned to a memory access request (e.g., 604 or 616) having a stream ID, and the tables are used to assign a corresponding first classification ID (e.g., ARID-1) to the request. The process of block 702 may be accomplished, according to one aspect, by the SVM manager 608 illustrated in FIG. 6, but it is also contemplated that the functionalities could be performed by the Virtual Memory Manager (e.g., 612 in FIG. 6 consisting of an IOMMU or SMMU) as well.

Method 700 further includes comparing the first classification ID assigned to the memory request with a second classification ID stored in at least one page table entry of a page table used to manage the SVM system, where the least one page table entry corresponds to one or more memory locations of the SVM being requested in the memory access request as shown in block 704. In an aspect, the comparison of block 704 is effectuated by the Virtual Memory Manger (e.g., 612 in FIG. 6), such as an IOMMU or SMMU, in conjunction with a page table of this manager (e.g., table 614 in FIG. 6). Additionally, this process of block 704 may be performed for a Stage 1 mapping for certain SMMUs. Still further, the second classification ID may be predetermined and stored in the page table entries (PTEs) of the page table, such as in extant bits of existing SMMUs. The pre-storage or predetermination of the second classification IDs may also be effectuated by the SVM manager 608 in one aspect, or by some other type of unit for performing the function in other aspects.

After the comparison in block 704, method 700 includes denying SVM system access operations for the memory access request (e.g., normal, standard, or customary access operations) if the first classification identifier does not match the second classification identifier as illustrated by block 706. The process of block 706 may also inherently include the alternative condition to permit SVM access operations to proceed if the first and second classification identifiers match (i.e., where the SVM access operations includes those normal, customary, or standard operations, such as permission operations, that are typically performed in IOMMUs or SMMUs). This permission does not necessarily mean that the memory access request will ultimately be permitted, but just that permission processes normally conducted in SMMUs or IOMMUs may continue. Thus, the process of block 706 affords an initial additional or overlaid permission request/check that affords the ability to check permissions on a per master basis at the outset of virtual memory requests. According to one example, the processes of block 706 may be implemented with the IOMMU or SMMU. In another example, the processes of block 706 may be implemented with additional hardware or software driver, such as with MM_SVM_Manager 512 illustrated in the example of FIG. 5.

According to another aspect, method 700 may include predetermining the at least one second classification ID information to be stored in at least one page table entry in the page table that is used for virtual memory access. In a further aspect, method 700 may also include the second classification ID in the page table being stored using existing PTE bits in at least one PTE of the page table. In yet a further aspect, a known four (4) bits in the PTE in page tables used in SMMUs may be used to store the second classification IDs.

In still a further aspect, method 700 may include that the page table is used for one or more of Stage 1 SVM memory access, Stage 2 SVM memory access, and access in a nested Stage 1 and Stage 2 SVM memory hierarchy in a System Memory Management Unit (SMMU). Furthermore, the first and second classification IDs represent a defined access control region of one or more memory addresses in the virtual memory system, such as an SMMU two stage virtual memory access including the use of IPAs in the SMMU for translation from VAs to PAs.

As mentioned earlier, it is noted the classification IDs may utilize some predefined nomenclature such a color coding. Accordingly, method 700 may also include the first and second classification IDs being represented by a nomenclature to classify the masters, wherein the nomenclature includes color coding in one example. Those skilled in the art will appreciate that other nomenclatures besides a color coding scheme or access areas could also be envisioned.

In yet another aspect, method 700 may also include in the process of assigning or tagging the first classification ID to the memory access requests from the memory masters by correlating of a stream identifier (SID) corresponding with the memory access request to the first classification ID, and assigning or tagging the first classification ID to the memory request based on the correlation. This process may be effectuated using the matching tables 606 and 618 in FIG. 6, for example, as well as the SVM manager 608.

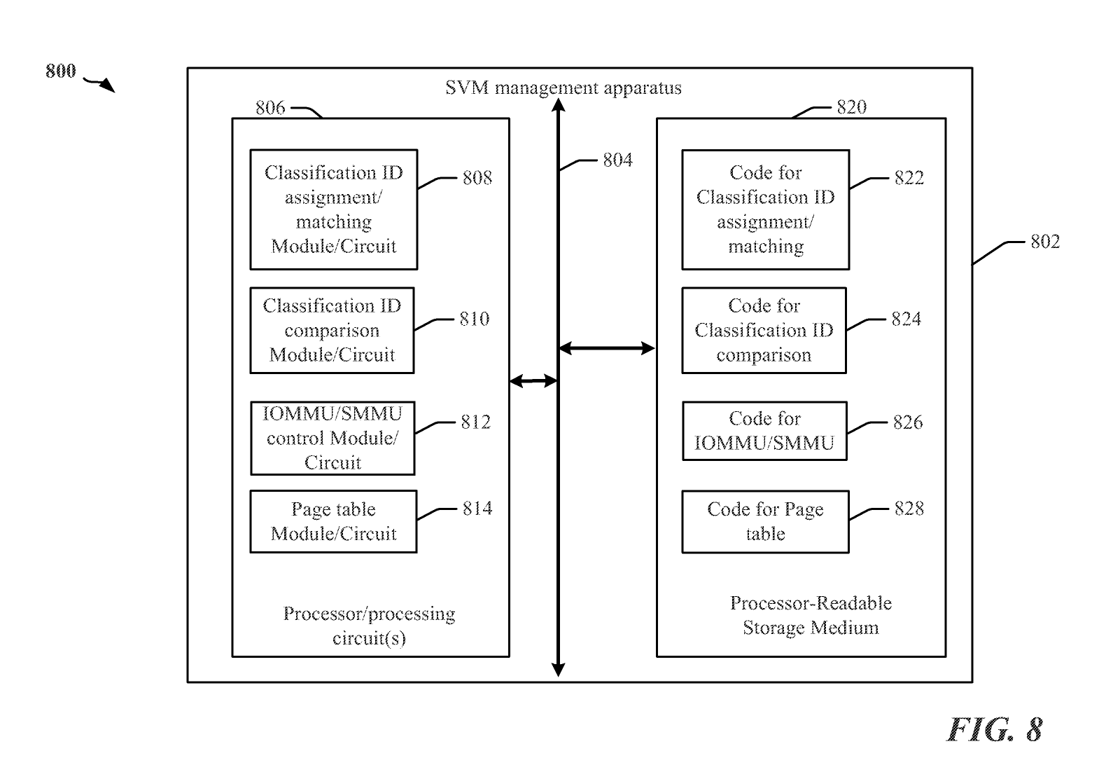

FIG. 8 is a diagram 800 illustrating a simplified example of a hardware implementation for an SVM management apparatus 802 for implementing the memory management processes disclosed herein. The SVM management apparatus 802 may be implemented with a bus architecture, represented generally by the bus 804. The bus 804 may include any number of interconnecting buses depending on the specific application of the SVM management apparatus 802 and the overall design constraints. The bus 804 links together various circuits including one or more processors and/or hardware modules, represented by processing circuit(s) 806, and associated modules or circuits 808, 810, 812, and 814, and a computer-readable or processor-readable storage medium 820, which contains code 822, 824, 826, 828 for causing the processor circuitry executing various processes and functions of the modules 808, 810, 812, 814. The bus 804 may also link various other circuits (not shown) such as timing sources, peripherals, various client circuitry and devices, power management circuits, digital signal processors, and RF modems in a device, such as a mobile phone.

The processing circuit(s) 806 is responsible for general processing, including the execution of software or code stored on the computer-readable storage medium 820. The code, when executed by the processing circuit(s) 806, causes the SVM management apparatus circuitry 802 to perform the various functions described herein for any particular apparatus. The code, when executed by the processing circuit(s) 806, may also cause the SVM management apparatus 802 to control logic and devices that are adapted to perform one or more of the various functions described before. The computer-readable storage medium 820 may also be used for storing data that is manipulated by the processing circuit(s) 806 when executing software.

The illustrated modules, means, or circuits 808, 810, 812, and 814 may be software modules running in the processor circuitry 806, but could also represent hardware or logic circuitry as well. The modules 808, 810, 812, and 814 may include microcontroller instructions, state machine configuration parameters, or some combination thereof.

In one configuration, the SVM management apparatus 800 may be a portion of an apparatus for wireless communication that includes systems utilizing shared virtual memory (SVM), where physical portions of the SVM may be resident in the medium 820, or in other storage media (not shown) in the apparatus. In the example of FIG. 8, the module 808 is configured for classification ID or ARID matching, as described earlier. In an aspect, the module 808 implements the SVM manager 608 shown in FIG. 6 and the associated matching and assigning/tagging of memory requests from memory masters (e.g., 602) using the SID to attach the classification ID or ARID (e.g., the first classification ID in the example of FIG. 7) to the memory request before buffering. Additionally, the module 808 may implement the matching tables 606 and 618 and direct buffering in buffers 610, 620, for example. The memory 820 includes code 822 used by the module 808 to execute the various functions performed by the module 808.

Further, module 810 is configured for performing comparison of classification IDs; namely comparing the classification ID or ARID attached to the memory requests from module 808 with a predetermined classification ID or ARID stored in a page table, which is implemented by module 814 (e.g., compare a first classification ID to a second classification ID as exemplified in the process 704 in FIG. 7. In an aspect, module 810 may, in part, implement the SVM manager 512 or 608 described before, or may also implement at least a portion of an IOMMU or SMMU dependent on desired configurations. The memory 820 includes code 824 and 828 used by the modules 810 and 814 to execute the various functions performed these modules. Additionally, it is noted that modules 810 and 814 may be implemented with hardware or logic circuitry as well.

Module 812 is configured for performing the modified functions of an IOMMU or SMMU disclosed herein, including determining an action based on the comparison of the first and second classification IDs. As detailed before, the IOMMU or SMMU (or even the SVM manager in other examples) can be configured to allow or deny memory access permission for particular memory requests based on whether the IDs match or not, such as illustrated in block 706 of FIG. 7. The memory 820 includes code 826 used by the modules 812 to execute the various functions performed this module. Additionally, it is noted that module 812 may be implemented with hardware or logic circuitry as well.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed examples is provided to enable any person skilled in the art to make or use the present invention. Various modifications to these examples will be readily apparent to those skilled in the art, and the generic principles defined herein may be applied to other embodiments without departing from the spirit or scope of the invention. Thus, the present disclosure is not intended to be limited to the examples shown herein but is to be accorded the widest scope consistent with the principles and novel features disclosed herein.

What is claimed is:

1. A method for memory management in a shared virtual memory (SVM) system comprising:
receiving a memory access request from a memory master;
assigning a first classification identifier (ID) to the memory access request from the memory master;
comparing the first classification ID assigned to the memory request with a second classification ID stored in at least one page table entry of a page table used to manage the SVM system, the at least one page table entry (PTE) corresponding to one or more memory locations of the SVM being requested in the memory access request; and
denying SVM system access operations for the memory access request if the first classification ID does not match the second classification ID.

2. The method of claim 1, further comprising:
permitting SVM system access operations for the memory access request to continue if the first classification ID matches the second classification ID.

3. The method of claim 1, further comprising:
predetermining at least one second classification ID to be stored in at least one page table entry in the page table that is used for virtual memory access.

4. The method of claim 1, wherein the second classification ID in the page table is stored using existing PTE bits in at least one PTE of the page table.

5. The method of claim 1, wherein the page table is used for one or more of Stage 1 SVM memory access, Stage 2 SVM memory access, and access in a nested Stage 1 and Stage 2 SVM memory hierarchy in a System Memory Management Unit (SMMU).

6. The method of claim 1, wherein the first and second classification IDs represent a defined access control region of one or more memory addresses in the virtual memory system.

7. The method of claim 1, wherein the first and second classification IDs may be represented by a nomenclature to classify the masters, wherein the nomenclature includes a color coding.

8. The method of claim 1, wherein assigning the first classification ID to the memory access request from the memory master further comprises:
correlating a stream identifier (SID) corresponding with the memory access request to the first classification ID; and
assigning the first classification ID to the memory request based on the correlation.

9. The method of claim 8, wherein correlating the SID to the first classification ID includes the use of a matching table.

10. An apparatus for memory management in a shared virtual memory (SVM) system comprising:
means for assigning a first classification identifier (ID) to a memory access request from a memory master;
means for comparing the first classification ID assigned to the memory request with a second classification ID stored in at least one page table entry of a page table used to manage the SVM system, the at least one page table entry (PTE) corresponding to one or more memory locations of the SVM being requested in the memory access request; and
means for denying SVM system access operations for the memory access request if the first classification ID does not match the second classification ID.

11. The apparatus of claim 10, further comprising:
means for permitting SVM system access operations for the memory access request to continue if the first classification ID matches the second classification ID.

12. A processor-readable storage medium having one or more instructions that, when executed by at least one processing circuit, cause the at least one processing circuit to:
assign a first classification identifier (ID) to a memory access request from a memory master in a shared virtual memory (SVM) system;
compare the first classification ID assigned to the memory request with a second classification ID stored in at least one page table entry of a page table used to manage the SVM system, the at least one page table entry (PTE) corresponding to one or more memory locations of the SVM being requested in the memory access request; and
deny SVM system access operations for the memory access request if the first classification ID does not match the second classification ID.

13. The storage medium of claim 12, wherein the storage medium includes instructions for causing the at least one processing circuit to:
permit SVM system access operations for the memory access request to continue if the first classification ID matches the second classification ID.

14. The storage medium of claim 12, wherein the storage medium includes instructions for causing the at least one processing circuit to:
predetermine at least one second classification ID to be stored in at least one page table entry in the page table that is used for virtual memory access.

15. The storage medium of claim 12, wherein the second classification ID in the page table is stored using existing PTE bits in at least one PTE of the page table.

16. The storage medium of claim 12, wherein the page table is used for one or more of Stage 1 SVM memory access, Stage 2 SVM memory access, and access in a nested Stage 1 and Stage 2 SVM memory hierarchy in a System Memory Management Unit (SMMU).

17. The storage medium of claim 12, wherein the first and second classification IDs represent a defined access control region of one or more memory addresses in the virtual memory system.

18. The storage medium of claim 12, wherein the first and second classification IDs may be represented by a nomenclature to classify the masters, wherein the nomenclature includes a color coding.

19. The storage medium of claim 12, wherein the storage medium includes instructions for causing the at least one processing circuit to:
correlate a stream identifier (SID) corresponding with the memory access request to the first classification ID; and
assign the first classification ID to the memory request based on the correlation.

20. The storage medium of claim 19, wherein the storage medium includes instructions to correlate the SID to the first classification ID includes the use of a matching table.

21. An apparatus for memory management in a shared virtual memory (SVM) system, the apparatus comprising:
at least one storage medium; and
at least one processing circuit coupled to the storage medium, the at least one processing circuit configured to:
assign a first classification identifier (ID) to a memory access request from a memory master;
compare the first classification ID assigned to the memory request with a second classification ID stored in at least one page table entry of a page table used to manage the SVM system, the at least one page table entry (PTE) corresponding to one or more memory locations of the SVM being requested in the memory access request; and
deny SVM system access operations for the memory access request if the first classification ID does not match the second classification ID.

22. The apparatus of claim 21, wherein the at least one processing circuit is further configured to:
permit SVM system access operations for the memory access request to continue if the first classification ID matches the second classification ID.

23. The apparatus of claim 21, wherein the at least one processing circuit is further configured to:
determine at least one second classification ID to be stored in at least one page table entry in the page table that is used for virtual memory access.

24. The apparatus of claim 21, wherein the second classification ID in the page table is stored using existing PTE bits in at least one PTE of the page table.

25. The apparatus of claim 21, wherein the page table is used for one or more of Stage 1 SVM memory access, Stage 2 SVM memory access, and access in a nested Stage 1 and Stage 2 SVM memory hierarchy in a System Memory Management Unit (SMMU).

26. The apparatus of claim 21, wherein the first and second classification IDs represent a defined access control region of one or more memory addresses in the virtual memory system.

27. The apparatus of claim 21, wherein the first and second classification IDs may be represented by a nomenclature to classify the masters, wherein the nomenclature includes a color coding.

28. The apparatus of claim 21, wherein the at least one processing circuit is further configured to:
correlate a stream identifier (SID) corresponding with the memory access request to the first classification ID; and
assign the first classification ID to the memory request based on the correlation.

29. The apparatus of claim 28, wherein correlating the SID to the first classification ID includes the use of a matching table.
